(19) United States
(12) Patent Application Publication
(10) Pub. No.: US 2016/0304015 A1
(43) Pub. Date: Oct. 20, 2016

(54) ODOR RESISTANT VEHICLE SEAT COVER

(71) Applicant: Andrew Kehl, Bellville, OH (US)

(72) Inventor: Andrew Kehl, Bellville, OH (US)

(21) Appl. No.: 14/691,526

(22) Filed: Apr. 20, 2015

(51) Int. Cl. B60N 2/60; A01M 31/00

(52) U.S. Cl. CPC B60N 2/6018; B60N 2/6063; B60N 2/6027; B60N 2/6036; B60N 2/6054; A01M 31/00

(57) ABSTRACT

The present invention relates to an odor resistant seat cover for a vehicle, comprising a scent barrier layer made of an odor absorbing material to prevent transfer of odor from a vehicle seat to a user. The seat cover completely encases a seating portion and a reclining portion of the vehicle seat. The seat cover further comprises one or more fastener members, for securing the seat cover to the vehicle seat.

### FIELD OF THE INVENTION

The present invention generally relates to a vehicle seating apparatus, and more particularly relates to an odor resistant vehicle seat cover for preventing the clothing and other gear of users from contamination with foreign scent or odor especially from the vehicle.

### BACKGROUND OF THE INVENTION

Elimination or masking of scent is crucial during hunting. Hunters tend to spend a lot of time, money and effort to eliminate human odor or any other foreign odor from their clothing and hunting gear by use of scent control products. Hunters may also use “cover scents” which smell like things normally occurring in the woods, such as, earth or dirt, and some animal urines, including fox urine. A variety of products exist in the market for scent control or scent masking such as scent eliminator boxes, scent masking detergents, sprays, wafers, wipes, soap, odorless oil, powder and the like.

Scent-free product companies promote a step-by-step process to eliminate human odor with the use of scent control products as mentioned above. However, one of the overlooked area which poses a high risk of contamination with foreign odor is hunter's vehicle, especially if hunters prefer to get dressed up at home or to get dressed up within the comfort of the vehicle itself. Vehicle's seat is generally contaminated with foreign odor that would cling to the hunting gear or clothing of the hunters and might ruin hunting.

Another choice involves hunters to get dressed up in the field and spray down with scent free products, which also poses limitations due to lack of comfort and harsh weather conditions including snow, rainfall, extreme temperatures, etc. Alternately, hunters may also use appropriate scents such as lures or attractants for masking the foreign odor.

In the prior-art, only a few patents exists relating to vehicle seat covers for preventing or controlling foreign odor. For example, U.S. Pat. No. 7,661,748 B2 shows a seat cover comprising a vapor barrier layer and an odor absorbing layer for preventing transfer of odor from a vehicle to a hunter. US patent publication no. 20070107662 shows a disposable protective cover for pet beds, automobile seats, automotive trunk interiors, furniture, comprising odor controlling or deodorizing mechanism. U.S. Pat. No. 6,761,404 B2 discloses a securable, protective seat cover in general for vehicles. U.S. Pat. No. 6,655,735 discloses a non-absorbing protective cover for a vehicle seat that resists absorption of liquid contaminates from the user. U.S. Pat. No. 5,806,925 shows a protective seat cover for automobile seats. US patent publication no. 20030085598 A1 relates to a disposable, highly absorbent vehicle seat cover and method of using the same.

Although a number of scent control products and methods exists for masking or eliminating foreign odor, it would be beneficial to provide an efficient method and apparatus for preventing or controlling the transfer of foreign odor from a vehicle seat to a user, especially for hunters, as the odor that might otherwise interfere with hunting.

### SUMMARY OF THE INVENTION

The present invention relates to an odor resistant seat cover for a vehicle, comprising: a scent barrier layer consisting an odor locking material adapted to prevent transfer of odor from a vehicle seat to a user. The seat cover is adapted to cover both front and rear sides of a seating portion and a reclining portion of the vehicle seat. The seat cover is designed to loosely fit over the vehicle seat, thus putting on or removing the cover is relatively simple. The seat cover further comprises at least one fastener member, for securing the seat cover to the vehicle seat.

In an embodiment, the seat cover is designed to fit to the size, shape and contours of the vehicle seat and comprises at least one fastener member, for securing the seat cover to the vehicle seat. Further, the seat cover can be custom designed to fit to the vehicle seat according to the vehicle make and model.

### BRIEF DESCRIPTION OF DRAWINGS

FIG. 1A and FIG. 1B illustrates a front view and a side view respectively, of the odor resistant seat cover secured to a vehicle seat, according to a first embodiment of the present invention.

FIG. 2A and FIG. 2B illustrates a front view and a side view respectively, of the odor resistant seat cover secured to a vehicle seat, according to a second embodiment of the present invention.

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims.

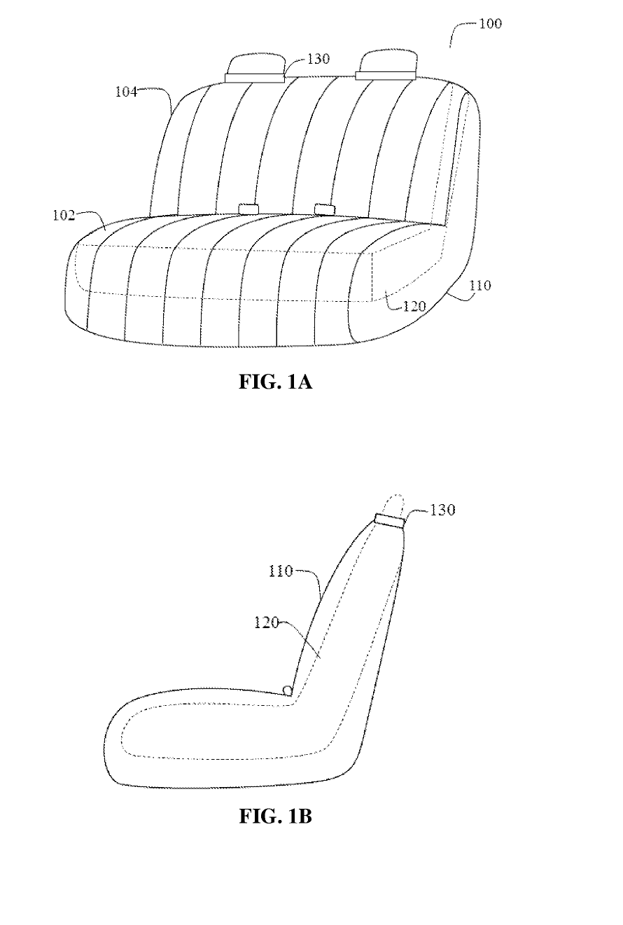

Referring to FIG. 1A and 1B, which illustrates a front view and a side view of the seat cover secured to a vehicle seat, according to a first embodiment of the present invention. The seat cover 100 comprises a scent barrier layer 110 comprising an odor locking material adapted to prevent transfer of odor from a vehicle seat 120 to a user. The seat cover 100 is configured to cover both front and rear sides of a seating portion 102 and a reclining portion 104 of the vehicle seat 120. In an embodiment, the seat cover 100 comprises two individual units adapted to cover the seating portion 102 and the reclining portion 104 separately.

In an embodiment, the seat cover 100 can be designed as a slip on type cover to loosely fit over the vehicle seat 120, for easy donning as well as easy removing for cleaning or replacement purposes. The seat cover 100 further comprises at least one fastener member 130 attached to the scent barrier layer 110, the fastener 130 secure the seat cover 120 to the vehicle seat 120 and hold it in place.

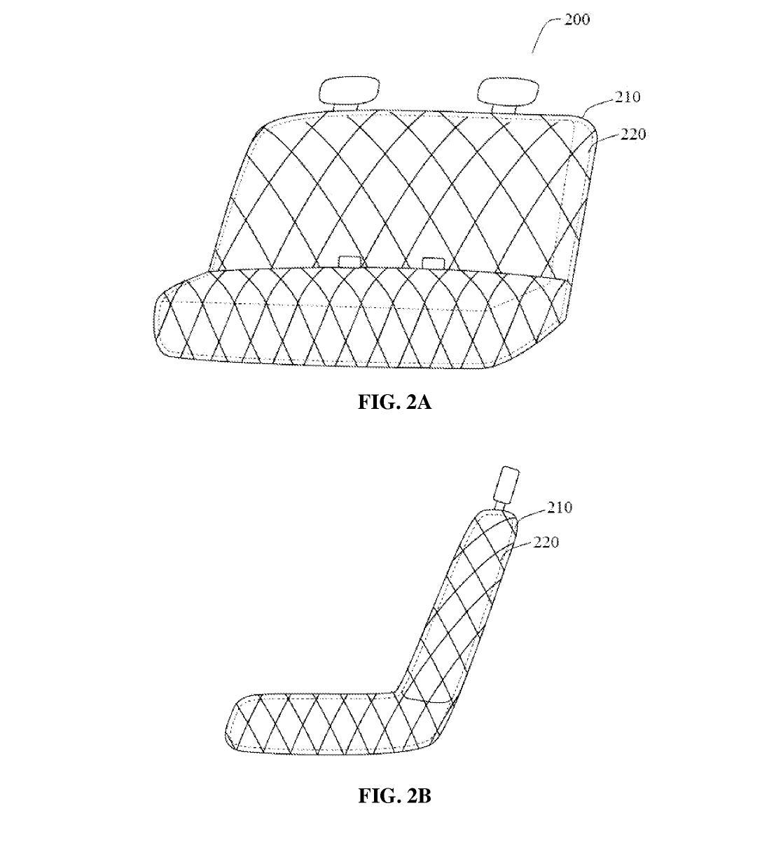

FIG. 2A and FIG. 2B illustrates a front view and a side view respectively, of the seat cover secured to a vehicle seat, according to a second embodiment of the present invention. The seat cover 200 comprises a scent barrier layer 210 adapted to prevent transfer of odor from a vehicle seat 220 to a user. The seat cover 200 is designed to fit to the size, shape and contours of the vehicle seat 220. Further, the seat cover can also be custom designed to fit to the vehicle seat according to the vehicle make and model.

One or more of the fastener elements can be selected from a group consisting of snap fasteners, draw strings, straps, elastic band, Velcro straps, hook and loop fasteners, zippers, or its combinations. The fastener holds the seat cover firmly in its place, after placing over the vehicle seat. In an embodiment, fastener member can be wrapped around a head rest of the reclining portion of the vehicle seat.

The scent barrier layer comprises of an odor locking or odor absorbing material, which can be selected from a group consisting of silver, carbon, copper and its combinations. The scent barrier layer thus prevents transfer of odor from the vehicle seat to the clothing or other gear of user.

In an exemplary embodiment, users especially hunters can get dressed up with hunting wear and hunting gear inside the comfort of the vehicle itself, as the seat cover with scent barrier layer prevents hunters clothing and gear from contamination with foreign odor, particularly from the vehicle seat. Alternatively, hunters can get dressed up at home and travel in their vehicles to hunting field without getting contaminated with foreign odor from vehicle seat.

The seat cover comprises a one or more custom made openings for receiving seat accessories, for example, it may comprise one or more narrow slit openings for allowing the seat belts to pass through. The seat cover may further comprise one or more openings or pockets for receiving the head rest of the vehicle seat.

The odor resistant seat cover of the present invention may further comprise an outer fabric layer covering the scent barrier layer. The outer fabric may be stretchable, laminated, water proof, non-absorbing, padded with cushion and/or coated with antimicrobial material, thereby contributing additional desired features besides odor resistance. The seat cover is removably attachable and can be easily removed for washing or cleaning purposes. The fabric can be selected from, but are not limited to, cotton and cotton blends, polyester, velour, leatherette, terrycloth, polycotton, knits, denim, cotton/spandex blends, neoprene, wool, orlons, olefins and any to blends thereof.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

1. A seat cover for a vehicle, comprising:
a scent barrier layer comprising a material adapted to prevent transfer of odor from a vehicle seat to a user, wherein the seat cover is adapted to cover a seating portion and a reclining portion of the vehicle seat; and
at least one fastener member, for securing the seat cover to the vehicle seat.

2. The seat cover of claim 1, wherein the material is selected from a group consisting of silver, carbon, copper and its combinations.

3. The seat cover of claim 1, wherein the fastener member comprises Velcro straps, draw strings, snap fasteners, straps, zippers or elastic band.

4. The seat cover of claim 1, wherein the fastener member is adapted to wrap around a head rest of the reclining portion of the seat.

5. The seat cover of claim 1, wherein the scent barrier layer comprises at least one opening for receiving a seat belt.

6. The seat cover of claim 1, is removably attachable to the vehicle seat.

7. The seat cover of claim 1, wherein the scent barrier layer is designed to fit to a size, shape and contour of the seat.

8. The seat cover of claim 1, further comprises an outer fabric layer covering the scent barrier layer.

9. The seat cover of claim 1 is adapted to cover a front portion and rear portion of the vehicle seat.
